(19) United States
(12) Patent Application Publication
(10) Pub. No.: US 2026/0354415 A1
(43) Pub. Date: Nov. 12, 2026

(54) AQUACULTURE FEED WITH PLANT-BASED CHOLESTEROL AND METHODS OF MAKING AND USING THE SAME

(71) Applicant: Cargill, Incorporated, Wayzata, MN (US)

(72) Inventor: Joshua Eugene Heatherly, Tracy, IA (US)

(73) Assignee: Cargill, Incorporated, Wayzata, MN (US)

(21) Appl. No.: 19/486,475

(22) PCT Filed: Jun. 5, 2024
(86) PCT No.: PCT/US2024/032474

§ 371 Date: Nov. 21, 2025

Related U.S. Application Data
(60) Provisional application No. 63/506,157, filed on Jun. 5, 2023.

(51) Int. Cl. A23K 20/105; A01K 61/59; A23K 20/147; A23K 20/158; A23K 20/163; A23K 40/25; A23K 50/80

(52) U.S. Cl. CPC A23K 20/105; A01K 61/59; A23K 20/147; A23K 20/158; A23K 20/163; A23K 40/25; A23K 50/80

(57) ABSTRACT

A feed for aquaculture feeding and methods of making and using such feeds are disclosed. The feed includes: a base feed component comprising protein, fat, and carbohydrates, and plant-based cholesterol, wherein the feed is free of land-mammal based cholesterol. The feed may include from 0.1 wt-% to 0.2 wt-% of total cholesterol, wherein 20% or more of the total cholesterol is plant-based. The feed may be free of land-mammal based components. The feed may be free of ruminant-based components. A method of making a feed includes mixing plant-based cholesterol with a base feed comprising protein, fat, and carbohydrates, and water to form a mixture; and compressing or extruding the mixture to form pellets, wherein the feed is free of land-mammal based cholesterol.

### CROSS-REFERENCE TO RELATED APPLICATIONS

This application claims the benefit of U.S. Provisional Patent Application No. 63/506,157, filed 5 Jun. 2023, which is hereby incorporated by reference in its entirety.

### SUMMARY

The present disclosure provides a feed for aquaculture feeding. The feed includes: a base feed component comprising protein, fat, and carbohydrates, and plant-based cholesterol, wherein the feed is free of land-mammal based cholesterol. The feed may include from 0.1 wt-% to 0.2 wt-% of total cholesterol, where 20% or more of the total cholesterol is plant-based. The feed may be free of land-mammal based components. The feed may be free of ruminant-based components.

The present disclosure provides a method of feeding an aquatic animal. The method includes feeding the aquatic animal a feed including: a base feed component comprising protein, fat, and carbohydrates, and plant-based cholesterol, wherein the feed is free of land-mammal based cholesterol. The feed may include from 0.1 wt-% to 0.2 wt-% of total cholesterol, where 20% or more of the total cholesterol is plant-based. The feed may be free of land-mammal based components. The feed may be free of ruminant-based components.

The present disclosure provides a method of making a feed. The method includes mixing plant-based cholesterol with a base feed comprising protein, fat, and carbohydrates, and water to form a mixture; and compressing or extruding the mixture to form pellets, wherein the feed is free of land-mammal based cholesterol.

The aquaculture feed of the present disclosure and methods of using the same have certain advantages over other aquaculture feeds. For example, in various aspects of the present technology, when fed to aquatic animals, the feed provides the desired nutrients, including cholesterol, without risking exposure to pathogens that may be present in mammalian sources of cholesterol.

### DEFINITIONS

All scientific and technical terms used herein have meanings commonly used in the art unless otherwise specified. The definitions provided herein are to facilitate understanding of certain terms used frequently herein and are not meant to limit the scope of the present disclosure.

The term “shrimp” is used here to refer to any and all species of shrimp and prawn. Commercially significant species of marine shrimp include Litopenaeus vannamei and Penaeus monodon, and freshwater shrimp (prawn) include Macrobrachium rosenbergii.

The term “plant-based” is used here to refer to compounds obtained from plants or compounds made by modifying compounds obtained from plants. Plants include eukaryotic organisms of the biological kingdom Plantae. The term plant-based is intended to distinguish materials obtained from animals or compounds made by modifying materials obtained from animals (e.g., fish meal). For the purposes of this disclosure, plant-based compounds may also include compounds sourced from fungi.

The term “animal-based” is used here to refer to materials obtained from animals or compounds produced from materials obtained from animals.

The term “land mammal” is used here to refer to mammals that primarily live on land. Examples of land mammals include pigs, sheep, goats, cattle, and the like.

The term “land-mammal based” is used here to refer to materials obtained from land mammals or compounds produced from materials obtained from land mammals.

The term “land-mammal pathogen” is used here to refer to pathogens that may be present in land-mammals and land-mammal based components.

The term “pathogen” is used here to refer to any micro-organism that may cause disease. Pathogens may include, for example, bacteria, viruses, viroids, prions, protozoa, and fungi.

The term “ruminant” is used here to refer to hoofed herbivorous mammals that have a rumen. Examples of ruminants include bovines (e.g., cattle), sheep, and goats.

The term “ruminant-based” is used here to refer to materials obtained from ruminants or compounds produced from materials obtained from ruminants.

The term “substantially” as used here has the same meaning as “significantly,” and can be understood to modify the term that follows by at least about 90%, at least about 95%, or at least about 98%. The term “substantially free” of a particular compound means that the compositions of the present invention contain less than 1,000 parts per million (ppm) of the recited compound.

The term “not substantially” as used here has the same meaning as “not significantly,” and can be understood to have the inverse meaning of “substantially,” i.e., modifying the term that follows by not more than 25%, not more than 10%, not more than 5%, or not more than 2%.

The term “about” is used here in conjunction with numeric values to include normal variations in measurements as expected by persons skilled in the art, and is understood to have the same meaning as “approximately” and to cover a typical margin of error, such as +5% of the stated value.

Terms such as “a,” “an,” and “the” are not intended to refer to only a singular entity, but include the general class of which a specific example may be used for illustration.

The terms “a,” “an,” and “the” are used interchangeably with the term “at least one.” The phrases “at least one of” and “comprises at least one of” followed by a list refers to any one of the items in the list and any combination of two or more items in the list.

As used here, the term “or” is generally employed in its usual sense including “and/or” unless the content clearly dictates otherwise. The term “and/or” means one or all of the listed elements or a combination of any two or more of the listed elements.

Values expressed in a range format should be interpreted in a flexible manner to include not only the numerical values explicitly recited as the limits of the range, but also to include all the individual numerical values or sub-ranges encompassed within that range as if each numerical value and sub-range were explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

Unless expressly stated, ppm (parts per million), percentage, and ratios are on a by weight basis. Percentage on a by weight basis is also referred to as wt % or % (wt) below.

As used here, “have,” “having,” “include,” “including,” “comprise,” “comprising,” or the like are used in their open-ended sense, and generally mean “including, but not limited to.” It will be understood that “consisting essentially of,” “consisting of,” and the like are subsumed in “comprising” and the like. As used herein, “consisting essentially of,” as it relates to a composition, product, method, or the like, means that the components of the composition, product, method, or the like are limited to the enumerated components and any other components that do not materially affect the basic and novel characteristic(s) of the composition, product, method, or the like.

The words “preferred” and “preferably” refer to embodiments that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the disclosure, including the claims.

### DETAILED DESCRIPTION

The Food and Agriculture Organization of the United Nations (The FAO) estimates that in 2019, approximately 56 metric tons of manufactured feed was fed to farmed fish and crustaceans. The global farmed shrimp production was estimated at about 6.6 metric tons in 2019, and the feed usage for the shrimp was estimated at 9 metric tons. Shrimp feeds are generally produced by pelleting (compression) or extrusion, with pelleting being still the primary method of production, particularly in Asia. See FAO. Extruded shrimp feeds improve performance, so why are they not more popular? Bangkok (2002). The expected growth of the global aquaculture industry may result in an increased demand and possibly even a shortage of certain raw materials. Bottlenecks may be caused, in particular, by fish meal and fish oil in feeds for marine fish and cholesterol in feeds for penaeid shrimp. See Coutteau, P., Raw Material Bottlenecks in Aqua Feed Formulation: Fish Meal and Cholesterol as Test Cases, In: Cruz-Suárez, L. E. et al. (Eds.). Avances en Nutrición Acuícola VI. Memorias del VI Simposium Internacional de Nutrición Acuícola. Cancún, Quintana Roo, México. (2002).

Shrimp are unable to synthesize cholesterol and, therefore, require cholesterol as part of their diet as an essential nutrient. Sources of cholesterol include fish meal, marine invertebrate meals, and oils. In addition, shrimp feed is typically supplemented with purified cholesterol to meet the nutritional needs of shrimp. Supplemental cholesterol is commonly purified from wool grease (lanolin) or other mammalian sources. But supplemental cholesterol can be expensive, and adding cholesterol to the feed may add significant cost to preparing the feed. Further improvements to cholesterol sources for aquaculture feeds are desired.

The present disclosure generally relates to aquaculture feeds that incorporate plant-based cholesterol and to methods of making and using such feeds. The present disclosure relates to methods of feeding aquatic animals a feed. The present disclosure further relates to feeds for crustaceans, such as shrimp, and the methods of feeding the crustaceans (e.g., shrimp).

As noted above, certain aquatic animals benefit from the inclusion of cholesterol in the feed. In fact, certain aquatic animals, such as shrimp, require cholesterol as part of their diet because they are incapable of synthesizing cholesterol in their bodies. The aquaculture feed of the present disclosure may be formulated for use in feeding shrimp or any other aquatic animal that may benefit from or have a need for cholesterol in their feed.

The aquaculture feed may include a base feed and one or more additives, where at least one of the additives is plant-based cholesterol. The base feed may include at least protein and fat. The aquaculture feed may be free of land-mammal based components. The aquaculture feed may be free of ruminant-based components. At least a portion of the cholesterol in the aquaculture feed may be obtained from plants or may be obtained by modifying components, such as phytosterols, obtained from plants. Such cholesterol is referred to here as plant-based cholesterol.

Avoiding the use of animal-based cholesterol and, in particular, land-mammal based cholesterol may be beneficial because it helps avoid the risk of exposing the animals receiving the feed to pathogens that may be present in mammalian sources of cholesterol. That is, when fed to aquatic animals, the feed provides the desired nutrients, including cholesterol, without risking exposure to pathogens that may be present in mammalian sources of cholesterol. The aquaculture feed of the present disclosure may be free or substantially free of land-mammal pathogens. The aquaculture feed preferably has less than a disease-causing amount of land-mammal pathogens. Using plant-based cholesterol may also reduce the risk of exposing the animals to antibiotics that may be used in animal husbandry, as well as reduce the need for fish oil, which is an increasingly scarce resource.

### Base Feed Components

The base feed includes at least protein and fat. The base feed may also include carbohydrates and other macro and micronutrients, such as vitamins and minerals. In some cases, the base feed is free of any ruminant-based components. In some cases, the base feed is free of any land-mammal based components. In some cases, the base feed includes components sourced from aquatic (e.g., marine) animals. In some cases, the base feed is free of animal-based components.

The levels of the various nutrients in the base feed may be adjusted based on different life stages of the intended target animal (e.g., shrimp). For example, a feed formulated for an early life stage may be more nutrient dense, while a feed formulated for a mature life stage may be less nutrient dense. In particular, earlier life stages may be fed a feed with high density of protein and fat that also includes a relatively high density of cholesterol. Additionally, the levels of the nutrients may be adjusted based on the stocking density of the target animals. A more densely stocked crop may be fed a more nutrient dense feed, while a less densely stocked crop may be fed a less nutrient dense feed.

The aquaculture feed may include protein at a concentration of 20 wt-% or more, 25 wt-% or more, 30 wt-% or more, or 35 wt-% or more. The protein concentration of the feed may be 55 wt-% or less, 50 wt-% or less, 45 wt-% or less, 40 wt-% or less, or 35 wt-% or less. The protein concentration of the feed may be in a range of 20 wt-% to 55 wt-%, 20 wt-% to 45 wt-%, 25 wt-% to 45 wt-%, or 35 wt-% to 45 wt-%. The protein may be from any suitable source, including plant and animal sources. In some cases, the protein may include marine protein, such as fish meal, krill, squid meal, and the like. In some cases, the protein includes plant proteins.

The aquaculture feed may include fat (lipids) at a concentration of 2 wt-% or more, 3 wt-% or more, or 4 wt-% or more. The fat concentration of the feed may be 20 wt-% or less, 15 wt-% or less, 10 wt-% or less, 9 wt-% or less, 8 wt-% or less, or 7 wt-% or less. The fat concentration of the feed may be in a range of 2 wt-% to 20 wt-%, 2 wt-% to 15 wt-%, 2 wt-% to 10 wt-%, or 4 wt-% to 10 wt-%. The fats may be from any suitable source, including plant and animal sources. In some cases, the fats may include plant oils, oil from animal origin, such as fish oil, and fats from other ingredients that contain fat (poultry meal, pork meat and bonemeal, wheat, soybean, DDG (distiller's dried grains), lecithin, canola, etc.).

Carbohydrates may be used to provide energy and to act as a binder of feed pellets. The aquaculture feed may include carbohydrates at a concentration of 8 wt-% or more, 10 wt-% or more, or 15 wt-% or more. The carbohydrate concentration of the feed may be 55 wt-% or less, 50 wt-% or less, 40 wt-% or less, or 35 wt-% or less. The carbohydrate concentration of the feed may be in a range of 10 wt-% to 55 wt-%, 20 wt-% to 45 wt-%, 20 wt-% to 40 wt-%, or 25 wt-% to 35 wt-%.

The aquaculture feed may also include one or more additional nutrients, such as phospholipids, highly unsaturated (DHA and EPA) omega-3 fatty acids, essential amino acids, available phosphorus, digestible energy, etc. The additional nutrients may be selected based on the intended use of the feed.

The aquaculture feed may include one or more micronutrients such as vitamins (e.g., vitamin A, vitamin B12 complex, vitamin C, vitamin D, vitamin E, choline, inositol, myoinositol, folic acid), calcium, phosphorus, zinc, copper, and other minerals.

The base feed may be made from any suitable ingredients that provide the desired nutrients. Exemplary ingredients and sources of ingredients for the base feed include various animal-based ingredients, such as fish, fish meal, fish oil, poultry, poultry meal, pork meat, bonemeal, krill, squid meal, and the like; plant-based ingredients, such as wheat, soybean, DDG(S) (distiller's dried grains, optionally with solubles), rice, lecithin, canola, algae, and the like; and mineral sources. The amounts of different ingredients may be selected based on the desired nutrient level (e.g., amount of protein or fat) and cost.

The base feed may further include fillers, such as calcium carbonate, processing aids, preservatives, etc.

The base feed may inherently include some cholesterol from the animal ingredients that may be used in the feed. For example, base feed by itself may satisfy up to 50% of the nutritional requirement for cholesterol for shrimp. The rest may be supplemented. Supplemental cholesterol is conventionally sourced from lanolin, fish oil, and various other animal parts. According to the present disclosure, the supplemental cholesterol is or includes plant-based cholesterol.

### Additives

### Plant-Based Cholesterol

The aquaculture feeds of the present disclosure include plant-based cholesterol. The supplemental cholesterol of the aquaculture feed may include plant-based cholesterol and cholesterol from fish oil. The supplemental cholesterol of the aquaculture feed may be predominantly plant-based. In some cases, the supplemental cholesterol of the aquaculture feed only includes plant-based cholesterol and does not include any animal-based cholesterol. The aquaculture feed may be free of any land-mammal based ingredients, including land-mammal sourced cholesterol. The aquaculture feed may be free of any ruminant-based ingredients, including ruminant-based cholesterol.

The plant-based cholesterol may be prepared from phytosterols obtained from plants. Phytosterols are a large group of steroid alcohols that include plant sterols and stanols (saturated sterols). Phytosterols generally have a fused tetracyclic structure including a side chain at position 17, shown generally in Formula (I):

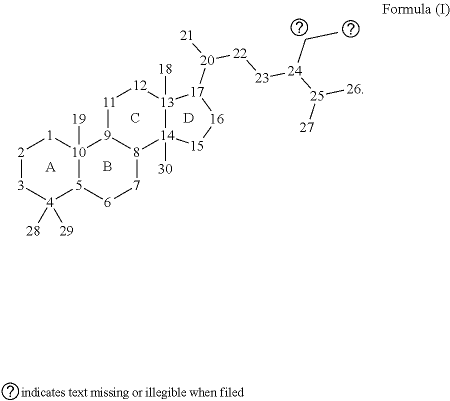

Phytosterols can be obtained from many plant sources. Typical commercial sources of phytosterols include seed oils, such as corn, soybean, rapeseed, tall oil pitch, algal oils, fungal oils, etc.

Cholesterol may be prepared from phytosterols by processes including enzymatic and/or chemical conversion. Cholesterol is represented by Formula (II):

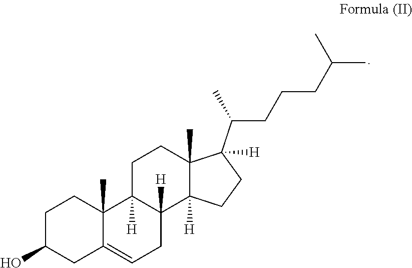

Plant-based cholesterol may be commercially available from Evonik Industries AG in Essen, Germany, Corden Pharma International in Plankstadt, Germany, or Croda International plc in Snaith, England.

The amount of cholesterol may be adjusted based on the intended use of the feed. For example, younger life stages of shrimp have a higher nutritional requirement for cholesterol than more mature life stages. Further, some species of shrimp benefit from a higher level of cholesterol, while others need less. Generally, the amount of cholesterol in the feed may be 0.09 wt-% or more, 0.1 wt-% or more, 0.11 wt-% or more, 0.12 wt-% or more, 0.13 wt-% or more, or 0.14 wt-% or more, based on the total weight of the feed. The amount of cholesterol may be 0.4 wt-% or less, 0.3 wt-% or less, or 0.2 wt-% or less, based on the total weight of the feed. The amount of cholesterol in the feed may range from 0.09 wt-% to 0.4 wt-%, 0.1 wt-% to 0.3 wt-%, 0.1 wt-% to 0.2 wt-%, 0.1 wt-% to 0.15 wt-%, or from 0.11 wt-% to 0.12 wt-%, based on the total weight of the feed.

Some of the cholesterol in the feed may be present in the base feed due to the fact that some of the ingredients of the base feed may inherently include cholesterol. However, at least a portion of the supplemental cholesterol may be plant based. In some cases, all of the supplemental cholesterol may be plant based. The amount of plant-based cholesterol in the feed may be 10 wt-% or more, 20 wt-% or more, 30 wt-% or more, 40 wt-% or more, 50 wt-% or more, 60 wt-% or more, 70 wt-% or more, 80 wt-% or more, or 90 wt-% or more of the total cholesterol in the feed. In some cases, the amount of plant-based cholesterol in the feed is 20 wt-% or more, 30 wt-% or more, 40 wt-% or more, 50 wt-% or more, 60 wt-% or more, and up to 75 wt-% of the total cholesterol in the feed. In some cases, the amount of plant-based cholesterol in the feed is between 40 wt-% and 60 wt-% of the total cholesterol in the feed.

The amount of plant-based cholesterol in the feed may be 0.02 wt-% or more, 0.04 wt-% or more, 0.05 wt-% or more, 0.1 wt-% or more, or 0.15 wt-% or more, based on the total weight of the feed. The amount of plant-based cholesterol in the feed may be 0.2 wt-% or less, 0.15 wt-% or less, 0.12 wt-% or less, 0.11 wt-% or less, 0.1 wt-% or less, 0.09 wt-% or less, 0.08 wt-% or less, 0.07 wt-% or less, or 0.06 wt-% or less, based on the total weight of the feed. The amount of plant-based cholesterol in the feed may be in a range of 0.02 wt-% to 0.2 wt-%, 0.04 wt-% to 0.12 wt-%, 0.04 wt-% to 0.08 wt-%, or 0.05 wt-% to 0.07 wt-%, based on the total weight of the feed.

### Other Additives

If the base feed does not include the desired amount of micronutrients, additional micronutrients may be included in the additives. For example, the additives may include vitamins (e.g., vitamin A, vitamin B12 complex, vitamin C, vitamin D, vitamin E, choline, inositol, myoinositol, folic acid), calcium, phosphorus, zinc, copper, and other minerals.

### Methods of Making

A method of making the feed may include preparing cholesterol by converting phytosterol into cholesterol. Alternatively, plant-based cholesterol may be obtained from a commercial source, such as Evonik Industries AG, Corden Pharma International, or Croda International plc. The feed may be prepared by mixing the plant-based cholesterol and optionally other additives with a base feed. The base feed may be prepared by mixing the base feed ingredients. Ingredients may include animal-based ingredients, such as fish, fish meal, fish oil, poultry, poultry meal, pork meat, bonemeal, krill, squid meal, and the like; plant-based ingredients, such as wheat, soybean, DDG(S) (distiller's dried grains, optionally with solubles), rice, lecithin, canola, algae, and the like; and vitamins, minerals, fillers, etc.; and combinations of any two or more thereof. The ingredients may be free of any land-mammal based ingredients, including land-mammal sourced cholesterol. The ingredients may be free of any ruminant-based ingredients, including ruminant-based cholesterol. Water may be added to the mixture to facilitate processing. The amount of water may be, for example, between 18-25 wt-%. The base feed component may include protein, fat, and carbohydrates as described above. The mixture may be further processed into pellets or a similar form. The mixture may be further processed, for example, by compressing (e.g., in a pelleting machine) or extruding. The pellets may be further dried to a final moisture content. The final moisture content of the feed pellets may be about 10-12 wt-%. Pellet sizes typically range from 0.3 mm to 1.2 mm diameter for starter pellets and 1.2 mm to 2.0 mm diameter for grower pellets. The length of the pellet is typically 2-3 times the diameter.

The feed made by methods of the present disclosure may be free of land-mammal based cholesterol. The feed made by methods of the present disclosure may be free of ruminant-based cholesterol. The feed made by methods of the present disclosure may include only plant-based cholesterol and no other types of cholesterol. In other words, the cholesterol in the feed may consist of plant-based cholesterol. The feed made by methods of the present disclosure may be free of land-mammal based components. The feed made by methods of the present disclosure may be free of land-mammal pathogens. The feed made by methods of the present disclosure may be free of ruminant-based components.

### Methods of Using

The aquaculture feed of the present disclosure may be used to feed any aquatic animals.

The feed may be fed at a rate that satisfies the dietary needs of the animal. The amount of feed and the formulation of the feed may be adjusted based on the life stage of the animal. If multiple different types of feeds are fed, at least 50%, at least 60%, at least 70%, at least 80%, at least 90%, at least 95%, at least 98%, or up to 100% of the cholesterol fed to the animals may be plant-based.

All references and publications cited herein are expressly incorporated herein by reference in their entirety into this disclosure, except to the extent they may directly contradict this disclosure. Although specific embodiments have been illustrated and described herein, it will be appreciated by those of ordinary skill in the art that a variety of alternate and/or equivalent implementations can be substituted for the specific embodiments shown and described without departing from the scope of the present disclosure. It should be understood that this disclosure is not intended to be unduly limited by the illustrative embodiments and examples set forth herein and that such examples and embodiments are presented by way of example only with the scope of the disclosure intended to be limited only by the claims set forth here.

1. A method of feeding an aquatic animal, the method comprising:
feeding the aquatic animal a feed comprising:
a base feed component comprising protein, fat, and carbohydrates, and plant-based cholesterol,
wherein the feed is free of land-mammal based cholesterol.

2. The method of claim 1, wherein the feed comprises from 0.1 wt-% to 0.2 wt-% of total cholesterol, and wherein 20% or more of the total cholesterol is plant-based.

3. The method of claim 1, wherein the feed comprises 0.11 wt-% to 0.12 wt-% of cholesterol.

4. The method of claim 1, wherein the feed is free of land-mammal based components.

5. The method of claim 1, wherein the feed is free of ruminant-based components.

6. The method of claim 1, wherein the feed is free of land-mammal pathogens.

7. The method of claim 1, wherein the feed is an extruded feed or a compressed feed.

8. The method of claim 1, wherein the aquatic animal is a shrimp.

9. A feed for aquaculture feeding, the feed comprising:
a base feed component comprising protein, fat, and carbohydrates, and
plant-based cholesterol,
wherein the feed is free of land-mammal based cholesterol.

10. The feed of claim 9, wherein the feed comprises from 0.1 wt-% to 0.2 wt-% of total cholesterol, and wherein 20% or more of the total cholesterol is plant-based.

11. The feed of claim 9, wherein the feed comprises 0.11 wt-% to 0.12 wt-% of cholesterol.

12. The feed of claim 9, wherein the feed is free of land-mammal based components.

13. The feed of any claim 9, wherein the feed is free of ruminant-based components.

14. The feed claim 9, wherein the feed is free of land-mammal pathogens.

15. The feed of claim 9, wherein the feed is an extruded feed or a compressed feed.

16. The feed of claim 9, wherein the aquatic animal is a shrimp.

17. A method of making a feed, the method comprising:
mixing plant-based cholesterol with a base feed comprising protein, fat, and carbohydrates, and water to form a mixture; and
compressing or extruding the mixture to form pellets,
wherein the feed is free of land-mammal based cholesterol.

18. The method of claim 17, wherein the feed comprises from 0.1 wt-% to 0.2 wt-% of total cholesterol, and wherein 20% or more of the total cholesterol is plant-based.

19. The method of claim 17, wherein the feed comprises 0.11 wt-% to 0.12 wt-% of cholesterol.

20. (canceled)

21. (canceled)

22. (canceled)

23. The method of claim 17, wherein the feed is formulation for feeding to shrimp.
